(19) United States
(12) Patent Application Publication
(10) Pub. No.: US 2026/0348232 A1
(43) Pub. Date: Nov. 5, 2026

(54) Window Film

(71) Applicant: LINTEC Corporation, Tokyo (JP)

(72) Inventors: Hiroki Minematsu, Tokyo (JP); Takayuki Arai, Tokyo (JP)

(73) Assignee: LINTEC Corporation, Tokyo (JP)

(21) Appl. No.: 19/100,151

(22) PCT Filed: Aug. 3, 2023
(86) PCT No.: PCT/JP2023/028452

§ 371 Date: Jan. 31, 2025

(30) Foreign Application Priority Data
Aug. 5, 2022 (JP) 2022-125737

(51) Int. Cl. E06B 9/24; G02B 5/20

(52) U.S. Cl. CPC E06B 9/24; G02B 5/208; E06B 2009/2417

(57) ABSTRACT

A window film includes a substrate and an adhesive layer disposed on one of main surfaces of the substrate, wherein the adhesive force of the adhesive layer to float glass after allowing to stand at 23 °C and a relative humidity of 50% for 24 hours is 1 N/25 mm or more, and the adhesive force of the adhesive layer to the float glass after allowing to stand at 80 °C for 168 hours is 18 N/25 mm or less.

### TECHNICAL FIELD

The present invention relates to window film.

### BACKGROUND ART

A window film is an adhesive film to be attached to a window of a mobile object such as an automobile or a building for adding, e.g., a shatterproof function, a function of shielding ultraviolet and infrared rays of the sun, and security performance to the window and is used in a wide variety of fields.

In order to sufficiently exhibit the shatterproof function, it is necessary for the window film to sufficiently fix to the window. That is, the window film is required to be highly adhesive to an adherend (e.g., window).

Meanwhile, the window film once attached to the adherend for a predetermined period is often released and replaced with another window film. Thus, the window film to be released is required not to leave adhesive residue (satisfactory re-releasability) on the surface of the adherend when released.

Thus, it is required for the window film to have properties contradictory to each other, i.e., strong adhesion and re-releasability, at the same time.

Patent Literatures 1 and 2 disclose that an adhesive sheet retains satisfactory initial adhesion force and satisfactory re-releasability when an adhesive composition contains a predetermined compound.

### CITATION LIST

### Patent Literature

Patent Literature 1: Japanese Patent No. 4236149
Patent Literature 2: Japanese Patent No. 4376491

### SUMMARY OF THE INVENTION

### Problem to be Solved by the Invention

As the result that the present inventors conducted intensive studies, they found that when a window film is released from the adherend after the passage of a predetermined period, the adhesive force at the time of release is extremely larger than the adhesive force at the time of adhesion due to the environmental load applied from the adhesion to release. As a result, adhesive residue is likely to remain on the surface of the adherend.

The present inventors also found that the phenomenon where the adhesive strength becomes very large at the time of release correlates with the adhesive strength in an aging test at a temperature higher than room temperature. Then, the present inventors found that when the adhesive force in the aging test at a temperature higher than room temperature falls within a predetermined range, the re-releasability can be improved, with the result that the strong adhesion and the re-releasability can be both obtained. Based on the finding, the present invention was accomplished.

The present invention was made in view of such circumstances. An object of the present invention is to provide a window film having an adhesive layer having both strong adhesion at the time of attachment and re-releasability after the passage of a predetermined period.

### Means for Solving Problem

Aspects of the present invention are as follows.
[1] A window film having a substrate and an adhesive layer disposed on one of main surfaces of the substrate, in which the adhesive force of the adhesive layer to float glass after allowing to stand at 23 °C and a relative humidity of 50% for 24 hours is 1 N/25 mm or more, and the adhesive force of the adhesive layer to the float glass after allowing to stand at 80 °C for 168 hours is 18 N/25 mm or less.
[2] The window film according to [1], in which the ratio of the storage elastic modulus of the adhesive layer at 23 °C to the storage elastic modulus of the adhesive layer at 80 °C is 3.5 or less.
[3] The window film according to [1] or [2], in which the adhesive force of the adhesive layer to the float glass after allowing to stand at 60 °C and a relative humidity of 95% for 168 hours is 22 N/25 mm or less.
[4] The window film according to any one of [1] to [3], including a hard coat layer disposed on the other main surface of the substrate.
[5] The window film according to any one of [1] to [4], in which the window film has ultraviolet absorptivity.
[6] The window film according to any one of [1] to [5], in which the window film has infrared absorptivity.

### Effects of the Invention

According to the present invention, it is possible to provide a window film having an adhesive layer having both strong adhesion at the time of attachment and re-releasability after the passage of a predetermined period.

### BRIEF DESCRIPTION OF DRAWINGS

FIG. 1A is a schematic cross-sectional view illustrating a window film according to the present embodiment.

FIG. 1B is a schematic cross-sectional view illustrating another window film according to the present embodiment.

### MODE(S) FOR CARRYING OUT THE INVENTION

Hereinafter, the present invention will be described in detail based on the embodiments.

### (1. Window Film)

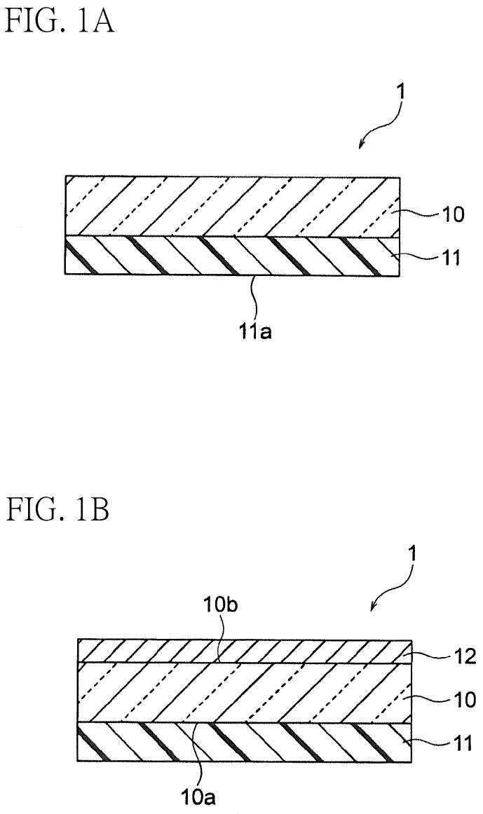

As shown in FIG. 1A, a window film 1 according to the present embodiment has a substrate 10 and an adhesive layer 11. The window film may have other constitutive elements as long as the effect of the present invention can be obtained. That is, the window film may have a layer other than the substrate and the adhesive layer. For example, a release sheet may be disposed on the main surface 11a of the adhesive layer 11 for protecting the adhesive layer 11 until it is attached to an adherend.

When the window film 1 is used, the exposed main surface 11a of the adhesive layer 11 is attached to an adherend (mainly a window of an automobile or a building) to exhibit a predetermined function.

As described above, the window film is required to have both strong adhesion for exhibiting a shatterproof function and re-releasability for suppressing adhesive residue at the time of release. However, if the adhesive layer of the window film has strong adhesion, adhesive force increases due to an environmental load from attachment to release. The stronger the adhesive force is, the higher the load is required for removing the window film and adhesive residue tends to remain on the surface of the adherend.

Thus, in the present embodiment, the physical properties of the adhesive layer are controlled as follows to obtain both strong adhesion at the time of attachment and re-releasability after the passage of a predetermined period. Hereinafter, the constitutive elements of the window film will be described in detail.

### (1.1. Substrate)

The substrate according to the present embodiment is a material responsible for rigidity of the window film, and has a function of supporting the adhesive layer. The material of the substrate is not particularly limited as long as it has the above function. In the present embodiment, it is preferable to use a resin material.

Examples of the resin material include a film made of a polyester resin such as polyethylene terephthalate and polyethylene naphthalate; a polyolefin resin such as polyethylene, polypropylene, poly(4-methylpentene)-1, and polybutene-1; a polyurethane resin; a polycarbonate resin; a polyvinyl chloride resin; a polyether sulfone resin; a polyethylene sulfide resin; a styrene resin; an acrylic resin; a polyamide resin; and a cellulose resin such as cellulose acetate, or a laminate film of these.

Among them, films formed of a polyolefin resin or a polyester resin having excellent mechanical strength and economic efficiency or a laminate film of these are preferable. In view of easily obtaining a window film satisfying the optical properties (described later), a film formed of a polyester resin or a laminate film of these is particularly preferable. Among them, a polyethylene terephthalate film or a laminate film containing polyethylene terephthalate is preferable.

The above laminate film is preferably a film obtained by laminating a plurality of layers formed of a single type of resin material or two or more types of resin materials. In the laminate film, a laminate film having wavelength selectivity due to a multilayer structure having at least two nanoscale layers is included. Note that, if a window film satisfying optical properties (described later) can be obtained, a laminate film not having wavelength selectivity or a laminate film having wavelength selectivity can be appropriately selected and suitably used. The term “wavelength selectivity” used herein refers to a property of absorbing or reflecting light in a specific wavelength region. The laminate film having wavelength selectivity refers to a laminate film capable of controlling transmittance in a predetermined wavelength region.

For improving adhesiveness to a layer provided on the substrate, a surface treatment may be applied to one or both surfaces of the substrate by, e.g., an oxidation method or a roughening method. Examples of the oxidation method include corona discharge treatment, chromic acid treatment (wet type), flame treatment, hot air treatment and ozone/ultraviolet irradiation treatment. Examples of the roughening method include a sandblasting method and a solvent treatment method.

The thickness of the substrate is not particularly limited as long as the substrate exhibits predetermined rigidity, and may be set appropriately according to the purpose of use. In the present embodiment, the thickness of the substrate is preferably 5 to 200 μm, more preferably 10 to 150 μm, and particularly preferably 15 to 100 μm in view of ensuring mechanical strength suitable for workability during attachment, and easily exhibiting the above-described physical properties of the adhesive. The thickness is preferably 20 to 80 μm, and particularly preferably 25 to 60 μm, in view of design to control optical properties (described later) mainly by a layer other than the substrate and in view of obtaining a thin window film.

The substrate may be transparent or colored. On the substrate, a metal such as aluminum, gold, silver, copper, nickel, cobalt, chromium, tin, or indium may be deposited.

### (1.2. Adhesive Layer)

The adhesive layer according to the present embodiment is mainly attached to the surface of a window of an automobile or a building, and fixes the window film to the surface of the window to allow the window film to exert a predetermined function. The window to which the adhesive layer according to the present embodiment is to be attached is preferably made of a glass material. The surface of the window to which the adhesive layer according to the present embodiment is to be attached may be a window surface on the side directly receiving sunlight or a window surface on the opposite side. More specifically, in the case of an automobile, the window surface may be a window surface present outside of the automobile or a window surface present inside of the automobile, similarly, in the case of a building, the window surface may be a window surface present outside the building or a window surface present inside the building. The adhesive layer 11 is preferably composed of an adhesive (described later).

The adhesive layer may be composed of one layer (single layer) or a plurality of layers (two or more). When the adhesive layer has a plurality of layers, these layers may be the same or mutually different, and a combination of these plurality layers is not particularly limited.

The thickness of the adhesive layer 11 is preferably 1 to 100 μm, more preferably 3 to 70 μm, further preferably 5 to 50 μm, particularly preferably 7 to 35 μm, and particularly preferably 10 to 25 μm or less. Due to this, suitable adhesion is easily exhibited, and both strong adhesion and re-releasability are easily obtained.

### (1.2.1. Physical Properties of Adhesive)

In the present embodiment, since the adhesive has the following physical properties, both the strong adhesion and the re-releasability of the window film can be obtained.

### (1.2.2. Initial Adhesive Force of Adhesive Layer)

In the present embodiment, when the adhesive layer attached to the float glass is allowed to stand at 23 °C and a relative humidity of 50% for 24 hours and then removed from the float glass, the adhesive force thereof is preferably 1 N/25 mm or more. This adhesive force is assumed to be the adhesive force at the time the window film is initially attached to the adherend. In the present embodiment, this adhesive force is defined as an initial adhesive force.

If the initial adhesive force falls within the above range, adhesion to an adherend (e.g., a surface of the window) becomes strong, with the result that the window film can be stably fixed to the adherend (e.g., a surface of the window). As a result, the window film can exhibit a satisfactory shatterproof function.

The initial adhesive force is preferably 1 to 100 N/25 mm, more preferably 4 to 75 N/25 mm, and still more preferably 8 to 50 N/25 mm. In view of easily controlling the heat-accelerated adhesive force (described later) to fall within a desired range or easily controlling the wet heat-accelerated adhesive force (described later) to fall within a desired range, the initial adhesive force is preferably 9 to 30 N/25 mm, particularly preferably 10 to 20 N/25 mm, and particularly preferably 11 to 14 N/25 mm. Specific measurement conditions for the initial adhesive force will be described later in Examples.

### (1.2.3. Heat Accelerated Adhesive Force of Adhesive Layer)

In the present embodiment, the adhesive layer attached to the float glass preferably has an adhesive force of 18 N/25 mm or less when the adhesive layer is released from the float glass after the layer is allowed to stand at 80 °C for 168 hours. This adhesive force is assumed to be an adhesive force with time after the window film is attached to the adherend and exposed to a high-temperature environment, and an adhesive force that changes due to an environmental load until the window film attached to the adherend is released. In the present embodiment, this adhesive force is defined as a heat-accelerated adhesive force.

If the heat-accelerated adhesive force falls within the above range, a change in adhesive force (particularly, an increase in adhesive force) due to an environmental load from attachment to an adherend (e.g., a surface of a window) to removal is suppressed. As a result, the re-releasability of the window film is improved.

The heat-accelerated adhesive force is preferably 1 to 18 N/25 mm, more preferably 5 to 17.5 N/25 mm, and still more preferably 10 to 17 N/25 mm. The measurement conditions for the heat-accelerated adhesive force will be more specifically described later in Examples.

### (1.2.4. Wet Heat-Accelerated Adhesive Force of Adhesive Layer)

In the present embodiment, the adhesive layer attached to float glass preferably has an adhesive force of 22 N/25 mm or less when the adhesive layer allowed to stand at 60 °C and a relative humidity of 95% for 168 hours is released from the float glass. This adhesive force is assumed to be an adhesive force with time after the window film is attached to the adherend and exposed to a high temperature and high humidity environment, more specifically, an adhesive force that changes depending on an environmental load applied from attachment of the window film to the adherend to release thereof. In the present embodiment, this adhesive force is defined as wet heat-accelerated adhesive force.

If the wet heat-accelerated adhesive force falls within the above range, a change in adhesive force (particularly, an increase in adhesive force) due to an environmental load applied from attachment to an adherend (e.g., a surface of a window) to release, is suppressed. As a result, the re-releasability of the window film is improved.

The wet heat-accelerated adhesive force is preferably 1 to 22 N/25 mm, more preferably 4 to 20 N/25 mm, and still more preferably 8 to 18 N/25 mm. In view of obtaining both initial adhesive force and heat-accelerated adhesive force, the wet heat-accelerated adhesive force is preferably 10 to 17 N/25 mm, and particularly preferably 11 to 16 N/25 mm. The measurement conditions for the wet heat-accelerated adhesive force will be more specifically described later in Examples.

### (1.2.5. Change Ratio of Storage Elastic Modulus)

In the present embodiment, the ratio (G′₂₃/G′₈₀) of the storage elastic modulus (G′₂₃) of the adhesive at 23 °C and a frequency of 1 Hz to the storage elastic modulus (G′₈₀) of the adhesive at 80 °C and a frequency of 1 Hz is preferably 3.5 or less. This ratio indicates a change ratio of the storage elastic modulus, and is an index indicating how much the storage elastic modulus at 80 °C changed from the storage elastic modulus at 23 °C. If the change ratio falls within the above range, the change in storage elastic modulus with temperature change tends to be small, and the increase in adhesive force with time tends to be suppressed.

The change ratio of the storage elastic modulus is preferably 1 to 3.5, more preferably 1.5 to 3.4, still more preferably 2 to 3.3, and particularly preferably 2.5 to 3.2.

Note that, as long as the change ratio of the storage elastic modulus falls within the above range, the values of the storage elastic modulus at 23 °C and the storage elastic modulus at 80 °C are not limited. However, in the present embodiment, the storage elastic modulus at 23 °C is preferably 0.001 to 1 MPa, more preferably 0.01 to 0.6 MPa, and still more preferably 0.03 to 0.3 MPa. In view of easily controlling, e.g., the initial adhesive force, the heat-accelerated adhesive force, and the wet heat-accelerated adhesive force described above to fall within desired ranges, the storage elastic modulus is preferably 0.05 to 0.15 MPa, and particularly preferably 0.07 to 0.11 MPa. Among them the storage elastic modulus of 0.09 to 0.105 MPa is preferable. In addition, the storage elastic modulus at 80 °C is preferably 0.001 to 1 MPa, preferably 0.01 to 0.5 MPa, and more preferably 0.02 to 0.1 MPa. In view of easily controlling, e.g., the initial adhesive force, the heat-accelerated adhesive force, and the wet heat-accelerated adhesive force described above to fall within desired ranges, the storage elastic modulus is preferably 0.025 to 0.05 MPa, and particularly preferably 0.03 to 0.034 MPa. If the storage elastic modulus at 23 °C and the storage elastic modulus at 80 °C fall within the above ranges, the change ratio of the storage elastic modulus is easily controlled to fall within the above range, and the initial adhesive force and re-releasability are easily improved.

The change ratio of the storage elastic modulus can be controlled, for example, by changing the composition of the adhesive, the crosslinked structure, the viscoelasticity, the weight average molecular weight of the main polymer constituting the adhesive, and the glass transition temperature thereof.

The storage elastic modulus (G′) may be measured by a commonly known method. For example, a sample of a predetermined size is taken from the adhesive layer and strained at a predetermined frequency in a predetermined temperature range by a dynamic viscoelasticity measuring device to measure the elastic modulus. Based on the measured elastic modulus, the storage elastic modulus in the above conditions can be calculated.

### (1.2.6. Gel Fraction of Adhesive)

The gel fraction of the adhesive according to the present embodiment is preferably 30 to 100%. Due to this, the adhesive force and the change ratio of the storage elastic modulus described above are easily satisfied, and both the initial adhesive force and the re-releasability are easily and favorably obtained.

The gel fraction of the adhesive according to the present embodiment is more preferably 40 to 95%, still more preferably 50 to 90%, and particularly preferably 60 to 80%. In view of easily controlling, e.g., the initial adhesive force, the heat-accelerated adhesive force, and the wet heat-accelerated adhesive force described above to fall within desired ranges, the gel fraction is preferably 63 to 75%, and particularly preferably 65 to 71%. The gel fraction of the adhesive may be measured by the method shown in Test Examples (described later).

### (1.3. Composition of Adhesive)

The composition of the adhesive according to the present embodiment is not particularly limited as long as the adhesive has the above-mentioned physical properties. For example, the adhesive may be any one of, e.g., an acrylic adhesive, a polyester adhesive, a polyurethane adhesive, a rubber adhesive, and a silicone adhesive. The adhesive may be an emulsion system, a solvent system or a solvent-free system. Furthermore, the adhesive may or may not have a cross-linked structure.

In view of, e.g., easiness of realizing the physical properties described above, physical properties of the adhesive and optical properties, the adhesive according to the present embodiment is preferably an acrylic adhesive and more preferably an acrylic adhesive having a crosslinked structure.

Specifically, the adhesive is preferably an adhesive obtained from an adhesive composition containing a (meth)acrylic acid ester polymer (A) (hereinafter, sometimes referred to as “adhesive composition P”), and is preferably an adhesive obtained by crosslinking an adhesive composition containing a (meth)acrylic acid ester polymer (A) and a crosslinking agent (B), that is, an adhesive composition containing a crosslinked product of a (meth)acrylic acid ester polymer (A) and a crosslinking agent (B). Such an adhesive easily satisfies the above-mentioned physical properties. Note that, in the specification, (meth)acrylic acid means both acrylic acid and methacrylic acid. The same applies to other similar terms. In addition, the term “polymer” includes the concept of “copolymer”.

### (1.3.1. (Meth)acrylic Acid Ester Polymer (A))

The (meth)acrylic acid ester polymer (A) preferably contains, as monomer units constituting the polymer, a (meth)acrylic acid alkyl ester and a monomer having a reactive functional group in the molecule (reactive functional group-containing monomer).

Due to the inclusion of a (meth)acrylic acid alkyl ester, the adhesive can exhibit preferable adhesion. The (meth)acrylic acid alkyl ester is preferably a (meth)acrylic acid ester of an alkyl group having 1 to 20 carbon atoms. The alkyl group may be linear or branched, or may have a cyclic structure.

Examples of the (meth)acrylic acid alkyl ester having an alkyl group having 1 to 20 carbon atoms include methyl (meth)acrylate, ethyl (meth)acrylate, propyl (meth)acrylate, n-butyl (meth)acrylate, isobutyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, and stearyl (meth)acrylate.

Among them, a (meth)acrylic acid alkyl ester having an alkyl group having 1 to 8 carbon atoms is preferable in view of adhesion and the change ratio of the storage elastic modulus. Specifically, n-butyl (meth)acrylate and isobutyl (meth)acrylate are preferable, and n-butyl acrylate and isobutyl acrylate are more preferable. Note that, these may be used alone, but are preferably used in combination.

The (meth)acrylic acid ester polymer (A) preferably contains 50 to 99.9 mass %, more preferably 60 to 99 mass %, still more preferably 70 to 95 mass %, and particularly preferably 80 to 90 mass % of a (meth)acrylic acid alkyl ester having an alkyl group having 1 to 20 carbon atoms as a monomer unit constituting the polymer. Due to this, the resulting adhesive easily exhibits suitable adhesion, and the change ratio of the storage elastic modulus is easily controlled to fall within the above-described range. In addition, a desired amount of another monomer component can be introduced into the (meth)acrylic acid ester polymer (A).

Due to the inclusion of the reactive functional group-containing monomer, the (meth)acrylic acid ester polymer (A) reacts with the crosslinking agent (B) (described later) via the reactive functional group derived from the reactive functional group-containing monomer to form a crosslinked structure (three-dimensional network structure) in the adhesive. As a result, an adhesive having a desired cohesive force is obtained. Due to this, the adhesive easily satisfies a physical property related to adhesive force described above.

Preferable examples of the reactive functional group-containing monomer include a monomer having a hydroxyl group in a molecule (hydroxyl group-containing monomer), a monomer having a carboxy group in a molecule (carboxy group-containing monomer), and a monomer having an amino group in a molecule (amino group-containing monomer). These reactive functional group-containing monomers may be used alone or in combination of two or more thereof. Among them, a hydroxyl group-containing monomer or a carboxy group-containing monomer is preferable. Due to this, a crosslinked structure via the crosslinking agent (B) is easily formed, and a physical property related to adhesive force described above is easily satisfied.

Examples of the hydroxyl group-containing monomer include a (meth)acrylic acid ester of a hydroxyalkyl group such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Among them, a (meth)acrylic acid alkyl ester having a hydroxyalkyl group having 1 to 4 carbon atoms is preferable in view of easily realizing a physical property related to adhesive force described above. Specifically, for example, 2-hydroxyethyl (meth)acrylate or 4-hydroxybutyl (meth)acrylate is preferable, 2-hydroxyethyl (meth)acrylate is more preferable, and 2-hydroxyethyl methacrylate is particularly preferable. These may be used alone or in combination of two or more.

Examples of the carboxy group-containing monomer include ethyleny unsaturated carboxylic acids such as acrylic acid, methacrylic acid, crotonic acid, maleic acid, itaconic acid, and citraconic acid. Among them, in view of reactivity of the carboxy group in the resulting (meth)acrylic acid ester polymer (A) with a crosslinking agent and copolymerization with other monomers, acrylic acid or methacrylic acid is preferable, and methacrylic acid is particularly preferable. These may be used alone or in combination of two or more.

The (meth)acrylic acid ester polymer (A) preferably contains 1 to 30 mass %, more preferably 2 to 20 mass %, still more preferably 4 to 15 mass %, and particularly preferably 6 to 10 mass % of a reactive functional group-containing monomer as a monomer unit constituting the polymer. Due to this, the cohesive force of the adhesive obtained by the crosslinking reaction with the crosslinking agent (B) becomes appropriate and a physical property related to adhesive force described above is easily satisfied.

When the (meth)acrylic acid ester polymer (A) contains both a hydroxyl group-containing monomer and a carboxy group-containing monomer as the reactive functional group-containing monomer, the (meth)acrylic acid ester polymer (A) preferably contains 1 to 30 mass %, more preferably 2 to 20 mass %, still more preferably 4 to 15 mass %, and particularly preferably 6 to 10 mass % of a hydroxyl group-containing monomer as a monomer unit constituting the polymer. In addition, the carboxy group-containing monomer is contained in an amount of preferably 0.01 to 1 mass %, more preferably 0.05 to 0.8 mass %, still more preferably 0.1 to 0.6 mass %, and particularly preferably 0.15 to 0.3 mass %. If the hydroxyl group-containing monomer and the carboxy group-containing monomer are contained within the above ranges, a desired cohesive force is exhibited due to satisfactory crosslinking reactivity with a crosslinking agent to easily obtain an adhesive that exhibits a desired physical property.

It is also preferable that the (meth)acrylic acid ester polymer (A) does not contain a carboxy group-containing monomer as a monomer unit constituting the polymer. If a carboxy group-containing monomer is not contained, it is easy to suppress an increase in adhesive force to an adherend (for example, glass) with time and to suppress adhesive residue at the time of release. In addition, since the carboxy group is an acid component, even when the object to be attached includes a transparent conductive film such as tin-doped indium oxide (ITO), a metal film, and a metal mesh, etc., which are subject to defects caused by acid, defects (corrosion, resistance change, etc.) can be suppressed due to acid.

Here, the phrase “does not contain a carboxy group-containing monomer” means that a carboxy group-containing monomer is not substantially contained. Other than a case where a carboxy group-containing monomer is not contained at all, a case where a carboxy group-containing monomer is contained to the extent that corrosion of, e.g., a transparent conductive film or a metal wiring due to a carboxyl group does not occur, is included. Specifically, a case where the (meth)acrylic acid ester polymer (A) contains a carboxy group-containing monomer as a monomer unit in an amount of 0.01 mass % or less, preferably 0.001 mass % or less, is included.

In the present embodiment, the (meth)acrylic acid ester polymer (A) preferably contains a monomer not containing a reactive functional group as a monomer unit constituting the polymer. This is because the above-described action of the reactive functional group-containing monomer is not inhibited. Examples of such a monomer include nonreactive nitrogen atom-containing monomers such as N-vinyl-2 pyrrolidone; (meth)acrylic acid alkoxyalkyl esters such as methoxyethyl (meth)acrylate and ethoxyethyl (meth)acrylate; vinyl acetate, and styrene. Among them, vinyl acetate is preferably contained since the resulting adhesive easily exhibits a desired adhesive force. These may be used alone or in combination of two or more.

The (meth)acrylic acid ester polymer (A) preferably contains 1 to 15 mass %, more preferably 2 to 10 mass %, and still more preferably 3 to 8 mass % of a monomer not containing a reactive functional group as a monomer unit constituting the polymer. Due to this, a physical property related to adhesive force described above is easily satisfied. The polymerization mode of the (meth)acrylic acid ester polymer (A) may be a random copolymer or a block copolymer.

The weight average molecular weight of the (meth)acrylic acid ester polymer (A) is preferably 200,000 to 2,000,000, more preferably 300,000 to 1,400,000, still more preferably 400,000 to 1,100,000, particularly preferably 450,000 to 900,000, and particularly preferably 500,000 to 800,000. Due to this, a physical property related to adhesive force described above is easily satisfied. Note that, the weight average molecular weight in the specification is a value in terms of standard polystyrene measured by a gel permeation chromatographic (GPC) method.

In the adhesive composition P, the (meth)acrylic acid ester polymer (A) may be used singly or in combination of two or more types thereof.

### (1.3.2. Crosslinking Agent (B))

The crosslinking agent (B) according to the present embodiment forms a crosslinked structure (three-dimensional network structure) by crosslinking with the (meth)acrylic acid ester polymer (A) in response to e.g., heating of the adhesive composition P containing the crosslinking agent (B). Due to this, the resulting adhesive is improved in cohesive force, the initial adhesive force of the adhesive layer can be increased, and an increase in adhesive force changed with time after attachment can be suppressed. Thus, the re-releasability of the resulting window film can be improved.

The above crosslinking agent (B) is satisfactory as long as it reacts with a reactive group of the (meth)acrylic acid ester polymer (A). Examples of the crosslinking agent include an isocyanate crosslinking agent, an epoxy crosslinking agent, an amine crosslinking agent, a melamine crosslinking agent, an aziridine crosslinking agent, a hydrazine crosslinking agent, an aldehyde crosslinking agent, an oxazoline crosslinking agent, a metal alkoxide crosslinking agent, a metal chelate crosslinking agent, a metal salt crosslinking agent, and an ammonium salt crosslinking agent. Among them, in view of crosslinkability with a (meth)acrylic acid ester polymer (A), an isocyanate crosslinking agent or an epoxy crosslinking agent is preferable, and an isocyanate crosslinking agent is particularly preferable. Note that, the crosslinking agent (B) may be used singly or in combination of two or more types thereof.

The isocyanate crosslinking agent contains at least a polyisocyanate compound. Examples of the polyisocyanate compound include aromatic polyisocyanates such as tolylene diisocyanate, diphenylmethane diisocyanate, and xylylene diisocyanate; aliphatic polyisocyanates such as hexamethylene diisocyanate; alicyclic polyisocyanates such as isophorone diisocyanate and hydrogenated diphenylmethane diisocyanate, and biuret products and isocyanurate products thereof, and adducts which are reactants with low molecular active hydrogen-containing compounds such as ethylene glycol, propylene glycol, neopentyl glycol, trimethylolpropane and castor oil. Among them, in view of reactivity with a hydroxyl group, a biuret product of an aliphatic polyisocyanate is more preferable, and a biuret product of hexamethylene diisocyanate is particularly preferable.

The content of the crosslinking agent (B) in the adhesive composition P is preferably 0.01 to 5 parts by mass, more preferably 0.1 to 3 parts by mass, particularly preferably 0.15 to 1 part by mass, further preferably 0.2 to 0.7 parts by mass, and particularly preferably 0.25 to 0.5 parts by mass based on 100 parts by mass of the (meth)acrylic acid ester polymer (A). Due to this, the aforementioned physical property related to adhesive force, and the physical property, i.e., the change ratio of the storage elastic modulus, are easily satisfied.

### (1.3.3. Ultraviolet Absorber (C))

The adhesive according to the present embodiment preferably contains an ultraviolet absorber in order to add an ultraviolet shielding function to the window film, and more preferably contains an ultraviolet absorber excellent in ultraviolet absorptivity and capable of controlling the ultraviolet transmittance (described later) to fall within a desired range. Due to this, the window film according to the present embodiment exhibits satisfactory ultraviolet absorptivity even if the window film is attached to a window surface on the side directly receiving sunlight or the opposite surface thereof.

Examples of the ultraviolet absorber include compounds such as benzophenone, benzotriazole, benzoate, benzoxazinone, methine, triazine, phenylsalicylate, cyanoacrylate, and a nickel complex salt. They may be used singly or in combination of two or more types thereof. Of the above ultraviolet absorbers (C), benzophenone, benzotriazole, and triazine compounds are preferably used, and benzophenone and triazine compounds are more preferably used.

Examples of the benzophenone compound include 2,2′-dihydroxy-4-methoxybenzophenone, 2,2′-dihydroxy-4,4′-dimethoxy benzophenone, 2,2′,4,4′-tetrahydroxybenzophenone, 2-hydroxy-4-methoxybenzophenone, 2,4-dihydroxybenzophenone, and 2-hydroxy-4-octoxybenzophenone.

Examples of the triazine compound include 2,4-bis(2-hydroxy-4 butoxyphenyl)-6-(2,4-dibutoxyphenyl)-1,3,5-triazine, 2,4,6-tris(2-hydroxy-4-octyloxyphenyl)-1,3,5-triazine, 2,4,6-tris[2-hydroxy-4-(3-butoxy-2-hydroxypropyloxy)phenyl]-1,3,5-triazine, and 2,4,6-tris(2-hydroxy-4-hexyloxy-3-methylphenyl)-1,3,5-triazine.

Examples of the benzotriazole compound include 2-(2′-hydroxy-3′,5′-di-tert-butylphenyl)-5-chlorobenzotriazole, 2-(2′-hydroxy-3′-tert-butyl-5′-methylphenyl)-5-chlorobenzotriazole, 2-(2′-hydroxy-3′-tert-amyl-5′-isobutylphenyl)-5-chlorobenzotriazole, 2-(2′-hydroxy-3′-isobutyl-5′-methylphenyl)-5 chlorobenzotriazole, 2-(2′-hydroxy-3′-isobutyl-5′-propylphenyl)-5-chlorobenzotriazole, 2-(2′-Hydroxy-3′,5′-di-tert-butylphenyl)benzotriazole, 2-(2′-hydroxy-5′-methylphenyl)benzotriazole, and 2-[2′-hydroxy-5′-(1,1,3,3-tetramethyl)phenyl]benzotriazole.

The content of the ultraviolet absorber (C) in the adhesive composition P is preferably 0.1 to 25 parts by mass, more preferably 0.5 to 18 parts by mass, still more preferably 1 to 12 parts by mass, and particularly preferably 4 to 10 parts by mass based on 100 parts by mass of the (meth)acrylic acid ester polymer (A). Due to this, the resulting adhesive layer can exhibit excellent ultraviolet ray shielding property. In addition, it is easy to obtain a window film satisfying optical properties such as ultraviolet transmittance (described later).

### (1.3.4. Crosslinking Accelerator (D))

The adhesive according to the present embodiment preferably contains a catalyst as a crosslinking accelerator for accelerating crosslinking of the (meth)acrylic acid ester polymer (A). Due to the inclusion of the crosslinking accelerator, the cohesive force of the adhesive is improved. As a result, the initial adhesive force of the adhesive layer can be increased, and an increase in adhesive force with time after attachment can be suppressed. Thus, the re-releasability of the window film can be improved.

Examples of the crosslinking accelerator include compounds of heavy metals such as tin, zinc, lead, mercury, and bismuth (including organometallic compounds); complexes of transition metals such as titanium, iron, copper, zirconium, nickel, cobalt and manganese, especially acetylacetonate complexes; amine compounds; and acid catalysts such as p-toluenesulfonic acid, phosphoric acid, hydrochloric acid, and ammonium chloride. Among them, an organotin compound and an amine compound are preferable, and an organotin compound is particularly preferable in view of the action of accelerating a crosslinking reaction. Note that, the crosslinking accelerator may be used singly or in combination of two or more types thereof.

Examples of the organotin compound include organotin compounds such as dimethyltin dichloride; fatty acid salts of organotin compounds such as dimethyltin dilaurate, dimethyltin di(2-ethylhexanoate), dimethyltin diacetate, dibutyltin dilaurate, dihexyltin diacetate, and dioctyltin dilaurate; thioglycolic acid ester salts of organotin compounds Is such as dimethyltin bis(isooctylthioglycolate) salts and dioctyltin bis(isooctylthioglycolate) salts; and metal soaps such as tin octanoate and tin decanoate. Among them, fatty acid salts of organotin compounds are preferable, and dibutyltin dilaurate is particularly preferable in view of the action of accelerating a crosslinking reaction.

The content of the crosslinking accelerator (D) in the adhesive composition P is preferably 0.001 to 1 part by mass, more preferably 0.002 to 0.5 parts by mass, and still more preferably 0.003 to 0.1 part by mass based on 100 parts by mass of the (meth)acrylic acid ester polymer (A). Due to this, both initial adhesive force and re-releasability of the adhesive layer can be easily obtained.

### (1.3.5. Other Additives)

The adhesive composition P may contain, if necessary, an additive commonly used for an acrylic adhesive. Examples of the additive include a tackifier, a filler, a softener, an antioxidant, a light stabilizer, a crosslinking agent, a colorant, a modifier, a rust inhibitor, a flame retardant, a hydrolysis inhibitor, a surface lubricant, a corrosion inhibitor, a heat resistant stabilizer, a lubricant, an antistatic agent, a polymerization inhibitor, a catalyst, a leveling agent, a thickener, a dispersant, an antifoaming agent, and a surfactant. Note that, the polymerization solvent and the dilution solvent (described later) are not included in the additives constituting the adhesive composition P.

Note that, in the present embodiment, it is preferable that a silane coupling agent is not used as an additive, in other words, the adhesive according to the present embodiment does not contain a silane coupling agent. This is because if a silane coupling agent is used, a silanol group generated by hydrolysis forms a covalent bond by a condensation reaction with Si—OH present on the glass surface particularly under wet heat conditions, with the result that the adhesive force tends to increase.

Here, the phrase “does not contain a silane coupling agent” means that the silane coupling agent is substantially not contained. Other than a case where the silane coupling agent is not contained at all, a case where the silane coupling agent is contained to the extent that adhesive force due to the silane coupling agent is not increased, is included. Specifically, a case where the adhesive composition P contains a silane coupling agent in an amount of 0.01 mass % or less, and preferably 0.001 mass % or less, is included.

### (1.4. Hard Coat Layer)

The window film according to the present embodiment may have a hard coat layer other than the substrate and the adhesive layer. In the present embodiment, as shown in FIG. 1B, in the case where the window film according to the present embodiment has a hard coat layer, the hard coat layer 12 is preferably disposed on a main surface 10b of the substrate 10, opposite to the main surface 10a on which the adhesive layer 11 is disposed. Furthermore, a case where a hard coat layer is disposed between the substrate 10 and the adhesive layer 11, is also preferable.

The hard coat layer is made of a material superior in, e.g., hardness, scratch resistance, and weather resistance, to the substrate. Since the window film is attached such that the adhesive layer faces an adherend, the hard coat layer is exposed to the outside. Thus, even if an external force is applied after attachment, the external force can be rarely transmitted to the adhesive layer and the adherend (e.g., a window of an automobile or a building). Thus, excellent impact resistance can be exhibited. Furthermore, even if the adherend is broken, it is possible to suppress the shards from scattering. Thus, excellent shatterproof function can be exhibited. Accordingly, safety can be enhanced while maintaining the appearance of a mobile object such as an automobile or a building.

The thickness of the hard coat layer is preferably 0.5 to 20 μm, more preferably 1 to 15 μm, particularly preferably 1.5 to 10 μm, and particularly preferably 2 to 6 μm in view of surface hardness, scratch resistance, and weather resistance of a window film.

The constituent material of the hard coat layer is not particularly limited as long as it is a material superior in, e.g., hardness, scratch resistance, and weather resistance, to the substrate. The hard coat layer according to the present embodiment is preferably formed of a cured product of a composition for forming a hard coat layer containing an energy ray-curable resin.

### (1.4.1. Composition for Forming Hard Coat Layer)

In the present embodiment, the composition Q for forming a hard coat layer may be composed of a thermosetting material or an energy ray-curable material. However, in view of productivity and easily obtaining desired scratch resistance, the composition Q is preferably composed of an energy ray-curable material, more preferably contains the energy ray-curable resin (a), and still more preferably contains the energy ray-curable resin (a) and a photopolymerization initiator (b).

### (1.4.2. Energy Ray-Curable Resin (a))

The energy ray-curable resin is not particularly limited, and can be selected from conventionally known ones. Examples of the resin include energy ray-curable monomers and oligomers. Alternatively, compositions containing them are included.

Examples of the energy ray-curable monomers include a polyfunctional (meth)acrylate. Examples of the energy ray-curable oligomers include urethane (meth)acrylate, polyester (meth)acrylate, polyether (meth)acrylate, and silicone (meth)acrylate.

Examples of the polyfunctional (meth)acrylate include pentaerythritol polyfunctional (meth)acrylate such as 1,4-butanediol di(meth)acrylate, 1,6-hexanediol di(meth)acrylate, neopentyl glycol di(meth)acrylate, ethylene glycol di(meth)acrylate, propylene glycol di(meth)acrylate, hexanediol di(meth)acrylate, trimethylolethane tri (meth)acrylate, trimethylolpropane tri(meth)acrylate, pentaerythritol tri(meth)acrylate and pentaerythritol tetra(meth)acrylate; dipentaerythritol polyfunctional (meth)acrylate such as dipentaerythritol penta(meth)acrylate, and dipentaerythritol hexa(meth)acrylate; glycerol tri(meth)acrylate, and triallyl (meth)acrylate.

Among them, pentaerythritol polyfunctional (meth)acrylate or dipentaerythritol polyfunctional (meth)acrylate is more preferable because, e.g., appropriate hardness, scratch resistance, and weather resistance can be added to the hard coat layer.

### (1.4.3. Photopolymerization Initiator (b))

When ultraviolet rays are used as an energy ray for curing the composition Q for forming a hard coat layer, the composition Q for forming a hard coat layer preferably contains a photopolymerization initiator (b). Due to the inclusion of the photopolymerization initiator, a hard coat layer can be efficiently formed when the composition Q for forming a hard coat layer is irradiated with ultraviolet rays. Here, the photopolymerization initiator refers to a compound that generates radical species by irradiation with an active energy ray such as ultraviolet rays.

Examples of the photopolymerization initiator include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 2-hydroxy-1-{4-[4-(2-hydroxy-2-methylpropionyl)benzyl] phenyl}-2-methylpropan-1-one, 1-hydroxycyclohexylphenyl ketone, 2-methyl-1-[4-(methylthio)phenyl]-2-morpholinopropanon-1-one, 4-(2-hydroxyethoxy)phenyl-2-(hydroxy-2 propyl) ketone, benzophenone, p-phenylbenzophenone, 4,4-diethylaminobenzophenone, dichlorobenzophenone, 2-methylanthraquinone, 2-ethylanthraquinone, 2-tertiary butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyldimethylketal, acetophenone dimethylketal, p-dimethylamine benzoic acid ester, and oligo [2-hydroxy-2 methyl-1-[4-(1-methylvinyl)phenyl]propan-1-one]. One of these may be used alone, or two or more thereof may be used in combination.

The content of the photopolymerization initiator (b) based on 100 parts by mass of the energy ray-curable resin (a) is preferably 1 to 30 parts by mass, more preferably 2 to 20 parts by mass, and still more preferably 3 to 10 parts by mass. Due to this, the resulting hard coat layer is likely to exhibit desired surface hardness and scratch resistance.

### (1.4.4. Infrared Absorber (c))

The composition Q for forming a hard coat layer according to the present embodiment also preferably contains an infrared absorber (c) in order to add heat shielding performance to the window film. The infrared absorber (c) is preferably an infrared absorbent excellent in near-infrared absorbency.

Examples of the infrared absorber (c) include organic infrared absorbers and inorganic infrared absorbers.

Examples of the organic infrared absorbers include cyanine compounds, squarylium compounds, thiol nickel complex salt compounds, naphthalocyanine compounds, phthalocyanine compounds, triarylmethane compounds, naphthoquinone compounds, and anthraquinone compounds, further include amino compounds such as a perchlorate of N,N,N′,N′-tetrakis(p-di-n-butylaminophenyl)-p-phenylenediaminium, a chlorate of phenylenediaminium, a hexafluoroantimonate of phenylenediaminium, a fluoborate of phenylenediaminium, a fluorate of phenylenediaminium, and a perchlorate of phenylenediaminium, and compounds obtained by the reaction between a copper compound and a bisthiourea compound, copper phosphate ester compounds obtained by the reaction between a phosphorus compound and a copper compound, and copper phosphate ester compounds obtained by the reaction between a phosphoric acid ester compound and a copper compound. An organic infrared absorber can be appropriately selected depending on weather resistance and required optical properties.

Examples of the inorganic infrared absorbent include titanium oxide, zirconium oxide, tantalum oxide, niobium oxide, zinc oxide, indium oxide, tin-doped indium oxide (ITO), tin oxide, antimony-doped tin oxide (ATO), zinc antimonate, cesium oxide, zinc sulfide, hexaboride (e.g., LaB₆, CeB₆, PrB₆, NdB₆, GdB₆, TbB₆, Dy B₆, HoB₆, YB₆, SmB₆, EuB₆, ErB₆, TmB₆, YbB₆, LuB₆, SrB₆, and CaB₆), and tungsten oxide compounds. Among them, a tungsten oxide compound, tin-doped indium oxide (ITO), and antimony-doped tin oxide (ATO) are preferable.

The content of the infrared absorber (c) in the composition Q for forming a hard coat layer is preferably 10 to 300 parts by mass, and more preferably 20 to 200 parts by mass based on 100 parts by mass of the energy ray-curable resin (a). Due to this, it is possible to obtain a window film that satisfies optical properties such as near infrared transmittance (described later).

Note that, in the present embodiment, in view of the scratch resistance of the window film, it is also preferable that the hard coat layer does not contain an infrared absorber. Since the infrared absorber is not contained, a material that can enhance the content ratio of the active energy ray curable resin in the hard coat layer or enhance the scratch resistance can be separately blended, with the result that it becomes easier to design for enhancement of scratch resistance and surface hardness.

Here, the phrase “the infrared absorber is not contained” means that an infrared absorber is substantially not contained. Other than a case where an infrared absorber is not contained at all, a case where an infrared absorber is contained to the extent that adhesive force does not increase due to the infrared absorber, is included. Specifically, a case where the composition Q for forming a hard coat layer contains the infrared absorber in an amount of 0.1 mass % or less, preferably 0.01 mass % or less, and particularly preferably 0.001 mass % or less, is included.

### (1.4.5. Leveling Agent (d))

The composition Q for forming a hard coat layer according to the present embodiment preferably contains a leveling agent (d) in view of, e.g., the weather resistance and antifouling property of the window film. Examples of the leveling agent include a silicone leveling agent, a fluorine leveling agent, an acryl leveling agent, and a vinyl leveling agent. Among them, in view of the above effect, a silicone leveling agent is preferable, and a silicone leveling agent having a cyclic siloxane structure is more preferable. Note that, the leveling agents may be used singly or in combination of two or more types thereof.

The content of the leveling agent (d) in the composition Q for forming a hard coat layer is preferably 0.001 to 1 part by mass, more preferably 0.01 to 0.5 parts by mass, still more preferably 0.02 to 0.1 part by mass, and particularly preferably 0.04 to 0.08 parts by mass based on 100 parts by mass of the energy ray-curable resin (a). Due to this, e.g., the weather resistance and antifouling property of the window film are improved without inhibiting the optical properties (described later).

### (1.4.6. Other Additives)

In addition, other additives can be appropriately contained within the range where the effects of the present invention are not impaired. Examples of other additives include an antioxidant, an ultraviolet absorber, an antistatic agent, a colorant, a polymerization accelerator, a polymerization inhibitor, a plasticizer, an antiviral agent, an antibacterial agent, a filler, and a diluent solvent.

### (1.5. Physical Properties of Window Film)

The window film according to the present embodiment preferably has the following physical properties.

The window film according to the present embodiment preferably has a light transmittance (ultraviolet transmittance) of 10% or less in a wavelength range of 300 to 380 nm. Due to this, the window film exhibits a satisfactory ultraviolet shielding function, and can suppress deterioration of members inside a building or an automobile, and can prevent rough skin and sunburn of people in the building or the automobile.

From the above viewpoint, the ultraviolet transmittance is preferably 5% or less, more preferably 1% or less, and most preferably 0%. The lower limit value of the ultraviolet transmittance is usually 0% or more.

The window film according to the present embodiment preferably has a transmittance of light (visible light) in a wavelength range of 380 to 780 nm of 98% or less, and more preferably 95% or less. Due to this, the presence of the window can be visually recognized. For example, a highly transparent window glass is extremely excellent in visibility, but there is a risk that a person is not aware of the presence of the window and hits to break the window. Thus, it is preferable that the window has high transparency but is easy to be recognized. On the other hand, if visibility through a window is required, the visible light transmittance is preferably 10% or more, more preferably 30% or more, still more preferably 50% or more, particularly preferably 70% or more, in particular, preferably 80% or more, and most preferably 90% or more, in view of improving visibility. Due to this, a landscape can be satisfactorily seen through a window of a building, and the scenery outside an automobile can be satisfactorily seen through a window of the automobile, with the result that safety during driving is enhanced.

The window film according to the present embodiment preferably has a light transmittance (near-infrared ray transmittance) of 90% or less in a wavelength range of 780 to 2500 nm. Due to this, the window film exerts satisfactory infrared heat shielding performance to successfully suppress the surface temperature of members and people inside a building or an automobile from increasing and to suppress the temperature of the internal space from increasing.

From the above viewpoint, the near-infrared transmittance is preferably 70% or less, preferably 50% or less, more preferably 40% or less, and still more preferably 30% or less. The lower limit value of the near-infrared transmittance is usually 0%, and, in view of balance with the visible-light transmittance, is preferably 10% or more, more preferably 20% or more, and still more preferably 30% or more.

Note that, the ultraviolet transmittance, the visible light transmittance, and the near-infrared transmittance of the window film described above can be measured by the methods shown in the test examples (described later).

The total thickness of the window film according to the present embodiment is preferably 5 to 200 μm, more preferably 10 to 160 μm, particularly preferably 20 to 140 μm, preferably 40 to 120 μm, further preferably 50 to 100 μm, and particularly preferably 60 to 80 μm. Due to this, handling of the window film becomes satisfactory and at the same time, desired physical properties of the adhesive become easily shown.

### (1.6. Production of Adhesive Composition)

The adhesive composition P can be produced, for example, by first producing a (meth)acrylic acid ester polymer (A) and mixing the obtained (meth)acrylic acid ester polymer (A) and a crosslinking agent (B). Additives may be added if necessary.

The (meth)acrylic acid ester polymer (A) can be produced, for example, by polymerizing a mixture of monomers constituting the polymer by a common radical polymerization method. The polymerization of the (meth)acrylic acid ester polymer (A) can be performed by a solution polymerization method using a polymerization initiator, if necessary.

Examples of the polymerization solvent used in the solution polymerization method include ethyl acetate, n-butyl acetate, isobutyl acetate, toluene, acetone, hexane, and methyl ethyl ketone. The polymerization solvents may be used singly or in combination of two or more types thereof. Examples of the polymerization initiator include azo compounds and organic peroxides. The polymerization initiators may be used in combination of two or more types thereof. Note that, in the above polymerization step, the weight average molecular weight of the resulting polymer can be controlled by blending a chain transfer agent such as 2-mercaptoethanol.

Subsequently, the crosslinking agent (B) and, if necessary, e.g., an ultraviolet absorber (C), a crosslinking accelerator (D) and a diluent solvent, are added to the solution of the obtained (meth)acrylic acid ester polymer (A), and the mixture is sufficiently mixed to obtain the adhesive composition P (coating solution) diluted with the solvent. Additives may be added if necessary.

Note that, when any of the above components is a solid component or a component that precipitates when it is mixed with another component in an undiluted state, the component may be dissolved or diluted alone with a diluent solvent in advance and then mixed with the other components.

Examples of the dilution solvent include aliphatic hydrocarbons such as hexane, heptane, and cyclohexane; aromatic hydrocarbons such as toluene and xylene; halogenated hydrocarbons such as methylene chloride and ethylene chloride; alcohols such as methanol, ethanol, propanol, butanol, and 1-methoxy-2 propanol; ketones such as acetone, methyl ethyl ketone, 2-pentanone, isophorone, and cyclohexanone; esters such as ethyl acetate and butyl acetate; and cellosolve solvents such as ethyl cellosolve.

The concentration and viscosity of the prepared coating solution may be satisfactory as long as coating can be performed, and can be appropriately selected according to the situation. For example, dilution is performed so that the concentration of the adhesive composition P is 10 to 60 mass %. Note that, when the coating solution is obtained, it is not necessary to add, e.g., a dilution solvent, and the dilution solvent may not be added as long as the adhesive composition P has a viscosity proper for coating. In this case, the adhesive composition P becomes a coating solution using the polymerization solvent of the (meth)acrylic acid ester polymer (A) directly used as a diluent solvent.

### (1.7. Production of Adhesive)

The adhesive constituting the adhesive layer is preferably obtained by crosslinking the adhesive composition P described above. The crosslinking of the adhesive composition P can be performed usually by heat treatment. Note that this heat treatment can be also performed by a drying treatment for volatilizing, e.g., a dilution solvent from the coating film of the adhesive composition P applied to a desired object.

The heating temperature of the heat treatment is preferably 50 to 150 °C, and more preferably 70 to 120 °C. The heating time is preferably 10 seconds to 10 minutes, and more preferably 50 seconds to 2 minutes.

After the heat treatment, an aging period of about 1 to 2 weeks at normal temperature (for example, 23 °C, relative humidity of 50%) may be provided if necessary. When aging is required, an adhesive having a crosslinked structure is obtained after the aging period. When aging is unnecessary, an adhesive having a crosslinked structure is obtained after completion of the heat treatment.

### (1.8. Production of Window Film)

The method for producing the window film is not particularly limited, and the window film may be produced by a commonly known method. For example, the coating liquid of the above adhesive composition P is applied onto one of the main surfaces of a substrate, and the adhesive composition P is crosslinked by heat treatment to form a coat layer having a predetermined thickness, and a release surface of a release sheet is superposed on the coat layer. Alternatively, the coating solution of the above adhesive composition P is applied to the release surface of the release sheet, and the adhesive composition P is crosslinked by heat treatment to form a coat layer having a predetermined thickness, and one of the main surfaces of the substrate is superposed on the coat layer.

When aging is required, the coat layer becomes an adhesive layer after aging is performed for a predetermined period. When aging is unnecessary, the coat layer becomes an adhesive layer as it is. Due to this, a window film is obtained.

When the window film has a hard coat layer, it is preferable to form the hard coat layer on the other main surface of the substrate before the adhesive layer is formed on one of the main surfaces of the substrate. In this case, first, the coating liquid of the above composition Q for forming a hard coat layer is applied onto the other main surface of the substrate and dried. After drying, the composition Q for forming a hard coat layer from which the solvent has been vaporized is irradiated with an active energy ray such as ultraviolet rays or an electron beam to cure. In this manner, a hard coat layer is formed on the substrate.

When ultraviolet rays are irradiated as an active energy ray, a commonly known device such as a high-pressure mercury lamp, a xenon lamp, or a metal halide lamp can be used as the ultraviolet irradiation device.

Examples of the method for applying the coating liquid of the adhesive composition P and the composition for forming a hard coat layer include a bar coating method, a knife coating method, a roll coating method, a blade coating method, a die coating method, and a gravure coating method.

Note that, in the specification, the description of “X to Y” (X and Y are arbitrary numbers) means “X or more and Y or less” unless otherwise specified, and, at the same time, the meaning of “preferably larger than X” or “preferably smaller than Y” is included. In addition, the description of “X or more” (X is any number) includes the meaning of “preferably larger than X” unless otherwise specified, and the description of “Y or less” (Y is any number) includes the meaning of “preferably smaller than Y” unless otherwise specified.

Although the embodiments of the present invention have been described above, the present invention is not limited to the above embodiments at all, and may be modified in various ways within the scope of the present invention.

### EXAMPLES

Hereinafter, the invention will be described in more detail with reference to Examples, but the present invention is not limited to these Examples.

### Example 1

### 1. Preparation of (Meth)acrylic Acid Ester Polymer (A)

A (meth)acrylic acid ester polymer (A) was prepared by copolymerizing 44 parts by mass of n-butyl acrylate, 44 parts by mass of isobutyl acrylate, 5 parts by mass of vinyl acetate, and 7 parts by mass of 2-hydroxyethyl methacrylate. When the molecular weight of the obtained (meth)acrylic acid ester polymer (A) was measured by the following method, a weight average molecular weight (Mw) thereof was 700,000.

The weight average molecular weight (Mw) is a weight average molecular weight in terms of polystyrene measured (GPC measurement) by gel permeation chromatography (GPC) in the following conditions.

### (Measurement Conditions)

GPC device: HLC-8020 manufactured by TOSOH CORPORATION
GPC column (passed in the following order): manufactured by TOSOH CORPORATION
TSK guard column HXL-H
TSK gel GMHXL (×2)
TSK gel G2000HXL
Measurement solvent: tetrahydrofuran
Measurement temperature: 40 °C.

### 2. Preparation of Adhesive Composition

The (meth)acrylic acid ester polymer (A) (100 parts by mass in terms of solid content; the same applies hereinafter) obtained in Step 1, 0.35 parts by mass (B1) of an isocyanate crosslinking agent (product name “TAKENATE D-165N” manufactured by Mitsui Chemicals, Inc.) as the crosslinking agent (B), 5 parts by mass (C1) of a benzophenone ultraviolet absorber (product name “CYASORB UV-24” manufactured by Solvay Japan) as the ultraviolet absorber (C), and 0.005 parts by mass of dibutyltin dilaurate (D1) as the crosslinking accelerator (D) were mixed, sufficiently stirred, and diluted with methyl ethyl ketone to obtain a coating solution of an adhesive composition having a solid-content concentration of 30 mass %.

### 3. Preparation of Composition for Forming Hard Coat Layer

Dipentaerythritol pentaacrylate (50 parts by mass) as the energy ray-curable resin (a), 50 parts by mass of dipentaerythritol hexaacrylate as the energy ray-curable resin (a), 5.0 parts by mass of 2-methyl-[4-(methylthio)phenyl]-2-morpholino-1-propane as the photopolymerization initiator (b), and 0.05 parts by mass of octamethylcyclotetrasiloxane as the leveling agent (d) were mixed, sufficiently stirred, and diluted with propylene glycol monomethyl ether to obtain a coating solution of a composition for forming a hard coat layer having a solid-content concentration of 30 mass %.

### 4. Production of Window Film

A polyethylene terephthalate (PET) film having a thickness of 50 μm was prepared as a substrate. The coating solution of the composition for forming a hard coat layer prepared in Step 3 was applied to one of the main surfaces of the PET film by gravure coating so that the dried film thickness became 3 μm, and heated at 70 °C for one minute to sufficiently remove the diluent solvent. Subsequently, the composition for forming a hard coat layer was cured by irradiating it with ultraviolet rays under a nitrogen atmosphere by an ultraviolet irradiation device (product name “Nitrogen purged small conveyor, UV irradiation device CSN2-40”, manufactured by GS Yuasa International Ltd.) under the following conditions to form a hard coat layer (thickness: 3 μm). In this manner, a PET film with a hard coat layer was obtained

### [Ultraviolet Irradiation Conditions]

Light source: high-pressure mercury lamp
Lamp power: 1.4 kW
Conveyor speed: 1.2 m/min
Illuminance: 120 mW/cm²
Light amount: 240 mJ/cm²

Subsequently, the coating solution of the adhesive composition prepared in Step 2 was applied by die coating to the release-treated surface of a release sheet (product name “SP-PET 381031”, manufactured by LINTEC Corporation), which was obtained by release-treating one of the surfaces of a polyethylene terephthalate film with a silicone release agent so that the dried film thickness became 20 μm. Then, heating was performed at 90 °C for one minute to sufficiently remove the diluent solvent to form an adhesive layer. In this manner, a laminate of the release sheet and the adhesive layer was obtained. The adhesive layer of the laminate was attached to the main surface, on which a hard coat layer is not formed, of PET film having the hard coat layer so as to be in contact with each other to obtain a window film.

### Examples 2 to 6 and Comparative Examples 1 to 4

A window film was produced in the same manner as in Example 1 except that the composition of the (meth)acrylic acid ester polymer (A) constituting the adhesive layer, the content of the crosslinking agent (B), the type of the ultraviolet absorber (C), the content of the crosslinking accelerator (D), the content of the silane coupling agent, and the type and content of the infrared absorber (c) to be added to the hard coat layer were changed as shown in Table 1.

TABLE 1

| | adhesive layer | | | | | | | |
|---|---|---|---|---|---|---|---|---|
| | | | Cosslinking | | Ultraviolet | | Crosslinking | |
| | (meth)acrylic acid ester | | agent (B) | | absorber (C) | | accelerator (D) | |
| | copolymer (A) | | | Parts by | | Parts by | | Parts by |
| | Composition | Mw | Type | mass | Type | mass | Type | mass |
| Example 1 | BA/i-BA/Vac/HEMA = | 700,000 | B1 | 0.35 | C1 | 5 | D1 | 0.005 |
| | 44/44/5/7 | | | | | | | |
| Example 2 | BA/i-BA/Vac/HEMA = | 700,000 | B1 | 0.35 | C2 | 5 | D1 | 0.005 |
| | 44/44/5/7 | | | | | | | |
| Example 3 | BA/i-BA/Vac/HEMA/MAA = | 700,000 | B1 | 0.35 | C1 | 5 | — | — |
| | 43.8/44/5/7/0.2 | | | | | | | |
| Example 4 | BA/i-BA/Vac/HEMA/MAA = | 700,000 | B1 | 0.35 | C1 | 5 | — | — |
| | 43.5/44/5/7/0.5 | | | | | | | |
| Example 5 | BA/i-BA/Vac/HEMA = | 700,000 | B1 | 0.35 | C1 | 5 | D1 | 0.005 |
| | 44/44/5/7 | | | | | | | |
| Example 6 | BA/i-BA/Vac/HEMA = | 700,000 | B1 | 0.35 | C1 | 5 | D1 | 0.005 |
| | 44/44/5/7 | | | | | | | |
| Comparative | BA/i-BA/Vac/HEMA = | 700,000 | B1 | 0.35 | C1 | 5 | — | — |
| Example 1 | 44/44/5/7 | | | | | | | |
| Comparative | BA/i-BA/Vac/HEMA = | 700,000 | B1 | 0.20 | C1 | 5 | D1 | 0.005 |
| Example 2 | 44/44/5/7 | | | | | | | |
| Comparative | BA/i-BA/Vac/HEMA/MAA = | 700,000 | B1 | 0.35 | C1 | 5 | D1 | 0.005 |
| Example 3 | 43/44/5/7/1 | | | | | | | |
| Comparative | BA/i-BA/Vac/HEMA = | 700,000 | B1 | 0.35 | C1 | 5 | — | — |
| Example 4 | 44/44/5/7 | | | | | | | |

| | adhesive layer | | Hard coat layer | | | | | | |
|---|---|---|---|---|---|---|---|---|---|
| | Silane coupling | | | Photopolymerization | | Near-infrared ray | | Leveling | |
| | agent | | Curable | initiator (b) | | shielding agent (c) | | agent (d) | |
| | | Parts by | resin (a) | | Parts by | | Parts by | | Parts by |
| | Type | mass | Composition | Type | mass | Type | mass | Type | mass |
| Example 1 | — | — | DPPA/ | b1 | 5.0 | — | — | d1 | 0.05 |
| Example 2 | — | — | DPHA = | | 5.0 | — | — | | 0.05 |
| Example 3 | — | — | 50/50 | | 5.0 | — | — | | 0.05 |
| Example 4 | — | — | | | 5.0 | — | — | | 0.05 |
| Example 5 | — | — | | | 5.0 | c1 | 180 | | 0.05 |
| Example 6 | — | — | | | 5.0 | c2 | 30 | | 0.05 |
| Comparative | — | — | | | 5.0 | — | — | | 0.05 |
| Example 1 | | | | | | | | | |
| Comparative | — | — | | | 5.0 | — | — | | 0.05 |
| Example 2 | | | | | | | | | |
| Comparative | — | — | | | 5.0 | — | — | | 0.05 |
| Example 3 | | | | | | | | | |
| Comparative | E1 | 0.1 | | | 5.0 | — | — | | 0.05 |
| Example 4 | | | | | | | | | |

Details of abbreviations used in Table 1 are as follows.
[Hard Coat Layer]
(Curable Resin (a))
DPPA: Dipentaerythritol pentaacrylate
DPHA: Dipentaerythritol hexaacrylate
(Photopolymerization Initiator (b))
b1: 2-Methyl-[4-(methylthio)phenyl]-2-morpholino-1-propane
(Infrared Absorber (c))
c1: Indium tin oxide
c2: Cesium-containing tungsten oxide (Product name “YMF-02AS” manufactured by Sumitomo Metal Mining Co., Ltd)
(Leveling Agent (d))
d1: Octamethylcyclotetrasiloxane
[Adhesive Layer]
((Meth)acrylic Acid Ester Polymer (A))
BA: n-Butyl acrylate
i-BA: Isobutyl acrylate
Vac: Vinyl acetate
HEMA: 2-Hydroxyethyl methacrylate
MAA: Methacrylic acid
(Crosslinking Agent (B))
B1: Isocyanate crosslinking agent (Product name “TAKENATE D-165N” manufactured by Mitsui Chemicals, Inc.)
(Ultraviolet Absorber (C))
C1: Benzophenone ultraviolet absorber (manufactured by Solvay Japan, product name “CYASORB UV-24”)
C2: Triazine ultraviolet absorber (Product name “Tinuvin 477” manufactured by BASF)
(Crosslinking Accelerator (D))
D1: Dibutyltin dilaurate
(Silane Coupling Agent)
E1: 3-Glycidoxypropyltrimethoxysilane

The following evaluations were performed using the window films prepared in Examples and Comparative Examples.

### (Initial Adhesive Force of Adhesive Layer)

The initial adhesive force of the window films prepared in Examples and Comparative Examples was measured as follows. The obtained window film was cut into pieces of 25 mm in width and 100 mm in length. The release sheet was removed from the above window film under an environment of 23 °C and a relative humidity of 50%, and the exposed adhesive layer was attached to a float glass plate having a thickness of 3 mm. At this time, the window film was attached by pressing the film by moving a 2 kg roller back and forth once to prepare a measurement sample for adhesive force. The obtained measurement sample was allowed to stand for 24 hours under the conditions of 23 °C and a relative humidity of 50%. After standing, the adhesive force (N/25 mm) of the adhesive layer was measured using a tensile tester (Tensilon manufactured by ORIENTEC CO., LTD.) under the conditions of a peel rate of 0.3 m/min and a peel angle of 180°. The measured value was defined as an initial adhesive force of the adhesive layer. Note that the conditions other than those described herein followed JIS Z0237:2009 and the measurement was performed. The results are shown in Table 2.

### (Heat Accelerated Adhesive Force of Adhesive Layer)

Heat accelerated adhesive force of the window films prepared in Examples and Comparative Examples was measured as follows. Samples for measuring adhesive force were prepared in the same manner as in the section of the initial adhesive force of the adhesive layers described above. The obtained measurement samples were allowed to stand still at 80 °C for 168 hours, followed by allowing them to stand still at 23 °C and a relative humidity of 50% for 24 hours. After stand-still, the adhesive force (N/25 mm) of the adhesive layers was measured under the conditions of 23 °C and a relative humidity of 50% using a tensile tester (Tensilon manufactured by ORIENTEC CO., LTD.) under the conditions of a peel rate of 0.3 m/min and a peel angle of 180°. Note that the conditions other than those described herein followed JIS Z0237:2009 and measurement was performed. The results are shown in Table 2.

### (Wet Heat Accelerated Adhesive Force of Adhesive Layer)

The wet heat accelerated adhesive force of the window films prepared in Examples and Comparative Examples was measured as follows. Samples for measuring adhesive force were prepared in the same manner as in the section of the initial adhesive force of the adhesive layers described above. The obtained measurement samples were allowed to stand still for 168 hours under the conditions of 60 °C and a relative humidity of 95%, followed by allowing them to stand still for 24 hours under the conditions of 23 °C and a relative humidity of 50%. After stand-still, the adhesive force (N/25 mm) of the adhesive layers was measured under the conditions of 23 °C and a relative humidity of 50% using a tensile tester (Tensilon manufactured by ORIENTEC CO., LTD.) under the conditions of a peel rate of 0.3 m/min and a peel angle of 180°. Note that the conditions other than those described herein followed JIS Z0237:2009 and measurement was performed. The results are shown in Table 2.

### (Storage Modulus G′ of Adhesive)

A plurality of adhesive layers of the laminate constituted of the release sheet and the adhesive layer obtained when the window film according to each of Examples and Comparative Examples was prepared was laminated to form a laminate having a thickness of 800 μm. A cylindrical body (height: 800 μm) of 8 mm in diameter was punched out from the obtained laminate of adhesive layers to prepare a measurement sample for storage elastic modulus.

The storage elastic modulus of the measurement sample was measured in accordance with JIS K7244-1 by a torsional shear method using a viscoelasticity measuring device (MCR301 manufactured by Anton Paar GmbH) under the conditions of a measurement temperature range of −20 to 140 °C, a measurement frequency of 1 Hz, and a temperature rising rate of 4 °C/min. From the measurement results, the storage elastic moduli at 23 °C and 80 °C were calculated. Furthermore, from the obtained storage elastic moduli at 23 °C and 80 °C, the ratio of the storage elastic modulus of the adhesive layer at 23 °C to the storage elastic modulus of the adhesive layer at 80 °C. (the change ratio of the storage elastic modulus) was calculated. The results are shown in Table 2.

### (Evaluation of Gel Fraction of Adhesive)

A laminate of a release sheet and an adhesive layer obtained in preparing each of the window films according to Examples and Comparative Examples, was cut into pieces of 50 mm×50 mm in size and the adhesive layer was wrapped in a mesh sheet made of polyester (product name: Tetrone mesh #200), and the mass of the adhesive layer was weighed by a precision balance. The mass of the adhesive was calculated by subtracting the mass of the above mesh sheet alone from the weighed value. The mass at this time was defined as M1.

Subsequently the adhesive wrapped in the above polyester mesh sheet was soaked in ethyl acetate at room temperature (23 °C) for 24 hours. Thereafter, the mesh sheet was taken out, air-dried in an environment of a temperature of 23 °C and a relative humidity of 50% for 24 hours, and further dried in an oven at 80 °C for 12 hours. After drying, the mass was weighed by a precision balance. The mass of the adhesive was calculated by subtracting the mass of the above mesh sheet alone from the weighed value. The mass at this time was defined as M2. Using the obtained M1 and M2, the gel fraction was calculated in accordance with the following formula. The results are shown in Table 2.

Gel fraction(%)=(M2/M1)×100

### (Optical Properties of Window Film)

The visible light transmittance, ultraviolet transmittance, and near-infrared transmittance of the window film were measured as follows. The release sheet was removed from the window films obtained in each of Examples and Comparative Examples, and the exposed adhesive layer was attached to a float glass plate of 3 mm in thickness. In accordance with JIS A 5759:2016, the light transmittance of the window film was measured by irradiating the window film with light in a wavelength range of 300 to 2500 nm by an ultraviolet-visible near-infrared spectrophotometer (UV-3600 manufactured by Shimadzu Corporation). From the measurement results, the light transmittance (ultraviolet transmittance) in the wavelength range of 300 to 380 nm, the light transmittance (near infrared transmittance) in the wavelength range of 780 to 2500 nm, and the light transmittance (visible light transmittance) in the wavelength range of 380 to 780 nm were calculated. The results are shown in Table 2.

### (Evaluation of Re-Releasability)

The re-releasability of the window film was evaluated as follows. At the time of measuring the adhesive force (initial adhesive force, heat accelerated adhesive force, and wet heat accelerated adhesive force) of the adhesive layer, the glass surface after the adhesive layer was removed was visually observed, the adhesive residue was evaluated based on the following criteria to evaluate the re-releasability. In the same manner as in the measurement of the adhesive force of the adhesive layer, the adhesive layer was attached to float glass, and then the adhesive layer was manually removed. The adhesive residue was evaluated based on the following criteria to evaluate the re-releasability. The results are shown in Table 2. The results shown in Table 2 are results obtained by comprehensively evaluating the re-releasability at the time of measuring the adhesive force and the re-releasability at the time of manual removal.
⊚: No adhesive residue
◯: Slightly cloudy with adhesive residue, but the residue can be easily wiped off
Δ: Adhesive residue partially remains
x: Adhesive residue remains over the entire attached surface

TABLE 2

| | Physical properties of adhesive layer | | | | | | | | | | | | |
|---|---|---|---|---|---|---|---|---|---|---|---|---|---|
| | Adhesive force (N/25 mm) | | | | | | | | | | | | |
| | | | Wet heat- | | | | | | | | | | |
| | | Heat- | acceler- | | | | | | | | | | |
| | Initial | acceler- | ated | | | | | | | | Optical properties of window film | | |
| | ad- | ated ad- | adhesive | | | | | | Change ratio | | Ultra- | Visible | Near |
| | hesive | hesive | force | Re-releasability | | | | | of storage | Gel | violet | light | infrared |
| | force 23 | force | 60 °C | 23° C | | 60° C | Storage elastic | | elastic | frac- | transmit- | transmit- | transmit- |
| | °C 50% × | 80 °C × | 95% × | 50% × | 80 °C × | 95% × | modulus(MPa) | | modulus | tion | tance | tance | tance |
| | 24 h | 168 h | 168 h | 24 h | 168 h | 168 h | 23 °C | 80 °C | G′₂₃/G′₈₀ | (%) | (%) | (%) | (%) |
| Example 1 | 13.8 | 16.8 | 14.9 | ⊚ | ⊚ | ⊚ | 0.097 | 0.033 | 2.98 | 71 | <1 | 91 | 83 |
| Example 2 | 11.2 | 14.3 | 11.3 | ⊚ | ⊚ | ⊚ | 0.098 | 0.032 | 3.12 | 70 | <1 | 91 | 83 |
| Example 3 | 13.4 | 17.0 | 13.3 | ⊚ | ⊚ | ⊚ | 0.105 | 0.033 | 3.16 | 69 | <1 | 91 | 83 |
| Example 4 | 13.7 | 17.4 | 14.0 | ⊚ | ◯ | ⊚ | 0.113 | 0.033 | 3.38 | 72 | <1 | 91 | 83 |
| Example 5 | 13.7 | 16.5 | 15.1 | ⊚ | ⊚ | ⊚ | 0.097 | 0.033 | 2.98 | 71 | <1 | 87 | 21 |
| Example 6 | 13.8 | 17.0 | 14.5 | ⊚ | ⊚ | ⊚ | 0.097 | 0.033 | 2.98 | 71 | <1 | 85 | 35 |
| Comparative | 16.3 | 22.6 | 14.3 | ⊚ | X | ⊚ | 0.106 | 0.023 | 4.61 | 62 | <1 | 91 | 83 |
| Example 1 | | | | | | | | | | | | | |
| Comparative | 18.5 | 22.4 | 17.9 | ⊚ | Δ | ⊚ | 0.098 | 0.027 | 3.60 | 64 | <1 | 91 | 83 |
| Example 2 | | | | | | | | | | | | | |
| Comparative | 14.7 | 19.3 | 16.3 | ⊚ | Δ | ⊚ | 0.127 | 0.035 | 3.62 | 71 | <1 | 91 | 83 |
| Example 3 | | | | | | | | | | | | | |
| Comparative | 16.8 | 23.0 | 25.0 | ⊚ | ◯ | X | 0.107 | 0.024 | 4.40 | 61 | <1 | 91 | 83 |
| Example 4 | | | | | | | | | | | | | |

From Table 2, it was found that the window films of Examples 1 to 6 have initial adhesive force and heat-accelerated adhesive force within predetermined ranges, and confirmed that the window films are excellent in initial adhesion and re-releasability.

### INDUSTRIAL APPLICABILITY

The window film of the present invention can be suitably used by attaching it to, for example, a window of a mobile object such as an automobile, or a building. In addition, the window film of the present invention can be attached to glass other than window glass or a glass substitute (for example, plastic).

### REFERENCE SIGNS LIST

1 Window film
10 Substrate
11 Adhesive layer
12 Hard coat layer

1. A window film having comprising:
a substrate and an adhesive layer disposed on one of main surfaces of the substrate, wherein
an adhesive force of the adhesive layer to float glass after allowing to stand at 23 °C and a relative humidity of 50% for 24 hours is 1 N/25 mm or more, and
an adhesive force of the adhesive layer to the float glass after allowing to stand at 80 °C for 168 hours is 18 N/25 mm or less.

2. The window film according to claim 1, wherein a ratio of a storage elastic modulus of the adhesive layer at 23 °C to a storage elastic modulus of the adhesive layer at 80 °C is 3.5 or less.

3. The window film according to claim 1, wherein an adhesive force of the adhesive layer to the float glass after allowing to stand at 60 °C and a relative humidity of 95% for 168 hours is 22 N/25 mm or less.

4. The window film according to claim 1, comprising a hard coat layer disposed on the other main surface of the substrate.

5. The window film according to claim 1, wherein the window film has ultraviolet absorptivity.

6. The window film according to claim 1, wherein the window film has infrared absorptivity.
